(19) United States
(12) Patent Application Publication
(10) Pub. No.: US 2017/0240741 A1
(43) Pub. Date: Aug. 24, 2017

(54) INTERIOR/EXTERIOR AUTOMOBILE TRIM COMPONENT

(71) Applicant: MAZDA MOTOR CORPORATION, Hiroshima (JP)

(72) Inventors: Yohei ICHIHARA, Hiroshima-shi, Hiroshima (JP); Haruo SASAKI, Kuwana-shi, Mie (JP)

(73) Assignee: MAZDA MOTOR CORPORATION, Hiroshima (JP)

(21) Appl. No.: 15/519,780

(22) PCT Filed: Dec. 3, 2015
(86) PCT No.: PCT/JP2015/006004

§ 371 Date: Apr. 17, 2017

(30) Foreign Application Priority Data
Dec. 3, 2014 (JP) 2014-244948

(51) Int. Cl. C08L 69/00; B60R 13/04; B60R 13/02

(52) U.S. Cl. CPC C08L 69/00; B60R 13/02; B60R 13/04; C08L 2205/025; C08L 2205/03

(57) ABSTRACT

Disclosed herein is an interior/exterior automotive trim component in which each of carbonate copolymers forming a polycarbonate resin composition is comprised of structural units derived from two or more different dihydroxy compounds. The structural units derived from the dihydroxy compounds include an ISB unit and a CHDM unit. In every one of the plurality of carbonate copolymers that form the polycarbonate resin composition, a molar ratio of the ISB unit to every dihydroxy compound unit in the carbonate copolymer is equal to or greater than 30 mol %. The molar ratio of the ISB unit to the CHDM unit in the polycarbonate resin composition satisfies 53/47≦ISB unit/CHDM unit≦56/44.

### TECHNICAL FIELD

The present invention relates to an interior/exterior automotive trim component of a polycarbonate resin composition obtained by melting and mixing together a plurality of carbonate copolymers with mutually different copolymerization ratios. More particularly, the present invention relates to an interior/exterior automotive trim component achieving a good product moldability rating while maintaining a sufficient thermal resistance and a moderate notched Charpy impact strength.

### BACKGROUND ART

Plastic has a relatively light specific gravity and is easily formed into any desired shape by injection molding, and therefore, has been used in a variety of fields. Among other things, plastic has been used particularly effectively as an impact-resistant material with good appearance for building materials, parts of electric and electronic devices, interior/exterior automotive trim components, and various other fields. In these fields requiring high impact resistance, a polyacrylate resin, a polycarbonate resin, and other suitable resins have heretofore been used.

Interior/exterior automotive trim components are often formed by injection molding due to its high productivity. If an injection molding process is performed with a polyacrylate resin, a polycarbonate resin, or any other suitable resin, however, the resultant injection-molded product may sometimes have a number of sink marks that destroy the integrity of the appearance of the molded product.

Furthermore, such an impact-resistant material suitably has ultraviolet (UV) resistance, a high surface hardness, a good tensile strength, a high optical transparency, a good impact strength, and a sufficient flame retardancy. A polyacrylate resin hardly discolors even when exposed to an ultraviolet ray, has a high surface hardness and a good transparency, but has a somewhat inferior mechanical strength and its flame retardancy is too low to make the resin a self-extinguishing grade one. These are some problems with a polyacrylate resin. Conversely, a polycarbonate resin has a good mechanical strength and self-extinguishing property, but significantly discolors under an ultraviolet ray and has a low surface hardness. These are some problems with a polycarbonate resin. When used outdoors, a resin with a low surface hardness will have its surface scraped by blowing sand and other particles during its use, which is likely to lead to a decrease in its transparency, and in a worst-case scenario, a decline in its mechanical strength. For that reason, surface hardness is one of the most important properties of such an impact-resistant material during its actual use.

A polyacrylate resin, a polycarbonate resin, and other resins are generally produced out of a raw material derived from petroleum resources. Recently, however, as concern about a possible depletion of such petroleum resources has been growing, there have been increasing demands for providing materials of plastic that uses a raw material derived from a biomass resource such as a plant. In addition, people are also worrying about a significant climate change and other unbeneficial phenomena to be caused by global warming that has been advancing year after year due to emission and accumulation of increasing amounts of CO₂ gas. Thus, more and more people are waiting for development of materials of plastic made from a plant-derived monomer that can be carbon-neutral even during its waste disposal process.

Someone proposed obtaining a polycarbonate resin by using isosorbide as a plant-derived monomer and producing a transesterification between isosorbide and diphenyl carbonate (see, for example, Patent Document 1). Other people are attempting to improve the stiffness of a homo-polycarbonate resin of isosorbide by copolymerizing isosorbide and an aliphatic dihydroxy compound (see, for example, Patent Document 2).

Among other things, a lot of people have proposed a polycarbonate obtained by polymerizing a cycloaliphatic dihydroxy compound such as 1,4-cyclohexanedimethanol (see, for example, Patent Documents 3-5). These patent documents do propose a polycarbonate resin including isosorbide, but give top priority to the color tone without paying attention to the mechanical and physical properties (e.g., impact resistance, in particular).

An aromatic polycarbonate resin which has been used extensively in the pertinent art exhibits excellent impact resistance in itself. Use of isosorbide, however, would require improvements, since isosorbide is inferior in impact resistance to an aromatic polycarbonate resin. Thus, to address this problem, a polycarbonate resin composition including a polycarbonate resin with a high glass transition temperature and a rubber-like polymer has been proposed as a possible replacement that would improve the impact resistance (see, for example, Patent Document 6).

Furthermore, other people teach making a resin composition with good stiffness (tensile modulus of elasticity), scratchproofness, and solvent resistance by mixing together an isosorbide homopolymer and a copolymer, and producing a surface protective film, a sheet and other products using this composition (see, for example, Patent Document 7).

### CITATION LIST

### Patent Documents

PATENT DOCUMENT 1: United Kingdom Patent No. 1079686
PATENT DOCUMENT 2: WO 04/111106
PATENT DOCUMENT 3: Japanese Unexamined Patent Publication No. H06-145336
PATENT DOCUMENT 4: Japanese Examined Patent Publication No. S63-12896
PATENT DOCUMENT 5: Japanese Unexamined Patent Publication No. 2008-24919
PATENT DOCUMENT 6: WO 08/146719
PATENT DOCUMENT 7: Japanese Unexamined Patent Publication No. 2009-79190

### SUMMARY OF INVENTION

### Technical Problem

The impact resistance of a resin has heretofore been improved by raising the molecular weight of the resin. If the resin (or resin composition) has a high glass transition temperature, however, its molecular weight cannot be raised to beyond a certain limit. This is because an excessively high molecular weight would make the melting viscosity too high at a polymerization reactor to remove the product from the reactor easily or to granulate the product easily. Thus, to avoid this problem, various methods, including the one blending a rubber-like polymer, have been proposed so far. None of these methods, however, facilitates achieving a good thermal resistance and a sufficient impact resistance at the same time or contributes to producing interior/exterior automotive trim components with good appearance on an industrial basis.

In addition, a homopolymer of isosorbide has a good thermal resistance but a low notched Charpy impact strength, and therefore, cannot be used to make desired interior/exterior automotive trim components.

Furthermore, as a technique for reducing the sink marks of a molded product, a method for increasing the fluidity of a resin by raising the temperature of the resin during the molding process has been proposed, for example. According to this method, however, the resin may be colored due to the heat history or the appearance of the resulting molded product may be marred by a decomposed gas generated under the heat. A method for increasing the fluidity of a resin by lowering the molecular weight of a resin has also been proposed. However, such a method will rather result in a lower impact resistance, contrary to expectations.

In view of the foregoing background, it is therefore an object of the present invention to provide an interior/exterior automotive trim component achieving a good product moldability rating while maintaining a sufficient thermal resistance and a moderate notched Charpy impact strength.

### Solution to the Problem

To achieve this object, the present inventors carried out intensive research to discover that an interior/exterior automotive trim component of a polycarbonate resin composition obtained by melting and mixing together a plurality of carbonate copolymers with mutually different copolymerization ratios would solve the problems described above, thus perfecting our invention. In this interior/exterior automotive trim component, each of the plurality of carbonate copolymers that form the polycarbonate resin composition may be comprised of structural units derived from two or more different dihydroxy compounds; the structural units derived from the dihydroxy compounds may include a structural unit derived from isosorbide and a structural unit derived from cyclohexanedimethanol; the polycarbonate resin composition may have a deflection temperature under load (at 1.80 MPa) of 83° C. or more; and the component may have a notched Charpy impact strength of 100 kJ/m² or more when a notch tip R is located at 0.75 mm.

Specifically, the present invention consists in:

[1] An interior/exterior automotive trim component of a polycarbonate resin composition obtained by melting and mixing together a plurality of carbonate copolymers with mutually different copolymerization ratios, wherein

each of the plurality of carbonate copolymers that form the polycarbonate resin composition is comprised of structural units derived from two or more different dihydroxy compounds,

the structural units derived from the dihydroxy compounds include a structural unit (ISB unit) derived from isosorbide and a structural unit (CHDM unit) derived from cyclohexane dimethanol,

in every one of the plurality of carbonate copolymers that form the polycarbonate resin composition, a molar ratio of the ISB unit to every dihydroxy compound unit in the carbonate copolymer is equal to or greater than 30 mol %, and

the molar ratio of the ISB unit to the CHDM unit in the polycarbonate resin composition satisfies the inequality:

53/47≦ISB unit/CHDM unit≦56/44.

[2] The interior/exterior automotive trim component of [1], wherein

the polycarbonate resin composition has a deflection temperature under load (at 1.80 MPa) of 83° C. or more.

[3] The interior/exterior automotive trim component of [1] or [2], wherein

the component has a notched Charpy impact strength of 100 kJ/m² or more when a notch tip R is located at 0.75 mm.

[4] The interior/exterior automotive trim component of any one of [1] to [3], wherein

each of the plurality of carbonate copolymers includes the ISB unit at a ratio of 90 mol % or less with respect to the structural unit derived from every one of the dihydroxy compounds that form the plurality of carbonate copolymers.

[5] The interior/exterior automotive trim component of any one of [1] to [4], wherein

if the sum of the plurality of different carbonate copolymers is 100 parts by weight, the polycarbonate resin composition includes 0.2 to 50 parts by weight of an elastic polymer.

[6] The interior/exterior automotive trim component of any one of [1] to [5], wherein

the component is formed by injection molding.

### Advantages of the Invention

The present invention provides an interior/exterior automotive trim component achieving a good product moldability rating while maintaining a sufficient thermal resistance and a moderate notched Charpy impact strength.

### DESCRIPTION OF EMBODIMENTS

Embodiments of the present invention will now be described in detail. Note that the following embodiments are mere examples of the present invention and therefore readily modifiable in various manners without departing from the true spirit and scope of the present invention.

In the following description of embodiments, a polycarbonate that has a particular composition, is obtained by condensation and polymerization reactions, and is not mixed with any other material, as will be described in detail later will be hereinafter referred to as a “carbonate copolymer.”

Also, in the following description of embodiments, a mixture of a plurality of carbonate copolymers having at least mutually different compositions will be hereinafter referred to as a “polycarbonate resin composition.”

Moreover, according to the present invention, the carbonate copolymer or the polycarbonate resin composition may include any of various additives.

Furthermore, in the following description of embodiments, the “dihydroxy compound unit” will refer herein to a structural unit derived from a dihydroxy compound. Likewise, a structural unit derived from isosorbide will be hereinafter sometimes referred to as an “isosorbide unit” and a structural unit derived from cyclohexanedimethanol will be hereinafter sometimes referred to as a “cyclohexanedimethanol unit.”

Also, in the following description of embodiments, the “copolymerization ratio” will refer herein to the mole percentage of a particular one of the dihydroxy compound units that form the carbonate copolymer to all of those dihydroxy compound units. That is to say, the sum of the respective copolymerization ratios of all of those dihydroxy compound units that form the carbonate copolymer is 100 mol %.

<<1>> Polycarbonate Resin Composition

A polycarbonate resin composition for use in the present invention is obtained by melting and mixing together a plurality of carbonate copolymers with mutually different copolymerization ratios. Each of the plurality of carbonate copolymers that form this polycarbonate resin composition is comprised of structural units derived from two or more different dihydroxy compounds, and includes a structural unit derived from isosorbide and a structural unit derived from cyclohexanedimethanol. The resin composition has a deflection temperature under load (at 1.80 MPa) of 83° C. or more. The component has a notched Charpy impact strength of 100 kJ/m² or more when a notch tip R is located at 0.75 mm

As used herein, the “plurality of carbonate copolymers with mutually different copolymerization ratios” may be obtained by copolymerizing isosorbide with a compound such as an aliphatic dihydroxy compound or a cycloaliphatic dihydroxy compound not only when their mole fractions are changed but also when the compounds themselves to be copolymerized with isosorbide are changed. The reason is that if each of the carbonate copolymers is copolymerized with a different compound from the other carbonate copolymers, their copolymerization ratios should be different from each other, even when their mole fractions are approximately equal to each other.

Any analytic technique may be used to determine whether or not a resin composition according to the present invention is a mixture of multiple different carbonate copolymers with mutually different copolymerization ratios. This analysis may be carried out, for example, in the following manner

Specifically, the analysis may be carried out with a sample dissolved in a solvent and measured by gradient polymer elution chromatography (GPEC).

The analysis may be carried out with conditions on the solvent, column and other specific parameters appropriately adjusted according to the physical property of the carbonate copolymer to be analyzed.

In the resin composition according to the present invention, a molar ratio of the isosorbide unit to every dihydroxy compound unit included in the resin composition is at least equal to 30 mol %, suitably equal to or greater than 40 mol %, and more suitably equal to or greater than 50 mol %. If the molar ratio were less than 30 mol %, then the resin composition would tend to have too low thermal resistance to be easily formed in a desired shape. On the other hand, the molar ratio is at most equal to 90 mol %, suitably equal to or less than 85 mol %, and more suitably equal to or less than 80 mol %. If the molar ratio were greater than 90 mol %, then the resin composition would tend to have decreased impact resistance.

It is beneficial to allow the molar ratio of the resulting resin composition to fall within the range specified above by melting and mixing together a carbonate copolymer including an isosorbide unit with a copolymerization ratio equal to or less than the lower limit molar ratio and a carbonate copolymer including an isosorbide unit with a copolymerization ratio greater than the lower limit molar ratio.

It is also beneficial to allow the molar ratio of the resulting resin composition to fall within the range specified above by melting and mixing together a carbonate copolymer including an isosorbide unit with a copolymerization ratio equal to or greater than the upper limit molar ratio and a carbonate copolymer including an isosorbide unit with a copolymerization ratio less than the upper limit molar ratio.

In the polycarbonate resin composition according to the present invention, the molar ratio of a structural unit derived from isosorbide (hereinafter sometimes referred to as an “ISB unit”) to a structural unit derived from cyclohexane dimethanol (hereinafter sometimes referred to as a “CHDM unit”) suitably satisfies the inequality:

53/47≦ISB unit/CHDM unit≦56/44

and more suitably satisfies the inequality:

54/46≦ISB unit/CHDM unit≦55/45

If their molar ratio were below this range, then the resulting resin composition could have insufficient thermal resistance. On the other hand, if their molar ratio were above this range, then the resulting resin composition could have insufficient impact resistance. This would be a problem in either way.

<Physical Properties of Polycarbonate Resin Composition>

(Deflection Temperature Under Load)

A polycarbonate resin composition according to the present invention suitably has a deflection temperature under load of at least equal to 83° C., more suitably equal to or higher than 85° C., and even more suitably equal to or higher than 90° C. when the deflection temperature is measured by the method to be described later. Generally speaking, the higher the deflection temperature under load of a composition is, the higher its thermal resistance tends to be, and the more effectively it may be used in an elevated temperature environment (e.g., when exposed to direct sunlight or used near a heat generator).

(Measurement of Deflection Temperature Under Load)

A pellet of a polycarbonate resin composition is dried at 80° C. for six hours with a hot air drier. Next, the pellet of the polycarbonate copolymer or resin composition thus dried is supplied to an injection molding machine (J75EII manufactured by the Japan Steel Works, Ltd.), thereby obtaining an ISO test piece to evaluate its mechanical and physical properties at a resin temperature of 240° C., a die temperature of 60° C., and a molding cycle time of 40 seconds.

Then, the ISO test piece to evaluate the mechanical and physical properties thus obtained has its deflection temperature under load measured under a load of 1.80 MPa by a method complying with the ISO75 standard.

(Notched Charpy Impact Strength)

A polycarbonate resin composition according to the present invention suitably has a notched Charpy impact strength of at least equal to 100 kJ/m², suitably equal to or greater than 103 kJ/m², and more suitably equal to or greater than 105 kJ/m², when the notched Charpy impact strength is measured by the method to be described later. Since the notched Charpy impact strength falls within this range, the polycarbonate resin composition is applicable extensively to various uses requiring impact resistance.

The upper limit of the notched Charpy impact test value is not particularly defined. However, a polycarbonate resin composition with a notched Charpy impact strength of greater than 200 kJ/m² is rarely used in the present invention. Thus, in practice, it is sufficient that the notched Charpy impact test value is 200 kJ/m² or less.

(Measurement of Charpy Impact Strength)

The ISO test piece to evaluate the mechanical and physical properties obtained as described above as a result of the (measurement of the deflection temperature under load) is subjected to machining to make a test piece, of which the notch tip R is located at 0.75 mm. In the other respects, the test piece is subjected to a notched Charpy impact test in compliance with the ISO 179 (2000). The higher this value is, the higher the impact resistance should be.

(Glass Transition Temperature)

A polycarbonate resin composition according to the present invention has at least two glass transition temperatures, at least one of which is suitably equal to or higher than 60° C., more suitably equal to or higher than 75° C. The glass transition temperature is beneficially equal to or higher than such a lower limit value to improve the resin composition's thermal resistance and thermal deformation resistance. On the other hand, at least another glass transition temperature of the polycarbonate resin composition is suitably equal to or lower than 150° C., more suitably equal to or lower than 140° C. The glass transition temperature is beneficially equal to or lower than such an upper limit value to improve the resin composition's moldability and productivity.

<<2>> Carbonate Copolymer

A polycarbonate resin composition according to the present invention is obtained by melting and mixing together a plurality of carbonate copolymers with mutually different copolymerization ratios as described above. Each of these carbonate copolymers is comprised of a structural unit derived from isosorbide and a structural unit derived from cyclohexanedimethanol

Carbonate copolymers for use in the present invention will now be described in detail.

<Dihydroxy Compounds>

Examples of dihydroxy compounds for use to make carbonate copolymers according to the present invention include isosorbide and cyclohexanedimethanol. In every one of the plurality of carbonate copolymers that form the polycarbonate resin composition of the present invention, a molar ratio of the ISB unit to every dihydroxy compound unit in the carbonate copolymer is at least equal to 30 mol %, suitably equal to or lower than 90 mol %, more suitably equal to or lower than 85 mol %, and most suitably equal to or lower than 80 mol %.

In the carbonate copolymers for use in the present invention, the molar ratio (ISB unit: CHDM unit) of the structural unit derived from isosorbide (ISB unit) to the structural unit derived from cyclohexanedimethanol (CHDM unit) is suitably in the range of 90:10 to 20:80, more suitably in the range of 80:20 to 30:70, and even more suitably in the range of 70:30 to 40:60. If the ratio of the ISB unit were above these ranges, the resin composition would be colored more easily. Conversely, if the ratio of the ISB unit were below these ranges, it would be difficult to achieve a high molecular weight or improve the impact resistance sufficiently. In addition, the glass transition temperature would tend to decrease in that case.

Each of the carbonate copolymers for use in the present invention may include not only the ISB unit and the CHDM unit but also an additional structural unit derived from any other dihydroxy compound (which will be hereinafter sometimes referred to as an “additional dihydroxy compound unit”). Examples of the additional dihydroxy compounds include aliphatic dihydroxy compounds and aromatic dihydroxy compounds other than isosorbide and cyclohexanedimethanol. The additional dihydroxy compound may be used alone. Alternatively, two or more additional dihydroxy compounds may be used in combination as well.

According to the present invention, the molar ratio of the total number of moles of the ISB and CHDM units to the number of moles of the additional dihydroxy compound units may be set arbitrarily. However, adjustment of this molar ratio would result in not only improvement of the impact resistance but also a desired glass transition temperature for the polycarbonate resin.

In at least one of the two or more types of carbonate copolymers that form the resin composition of the present invention, the structural unit derived from one of the two or more types of dihydroxy compounds forming the carbonate copolymer which accounts for the smallest number of moles suitably has a copolymerization ratio of at least 20 mol %, more suitably 30 mol % or more. On the other hand, the structural unit derived from a dihydroxy compound that accounts for the largest number of moles suitably has a copolymerization ratio of at most 80 mol %, more suitably 70 mol % or less. If the monomer ratio fell out of these ranges, the compatibility between the plurality of copolymers to be melted and mixed together would decrease so much as to lead to a decline in transparency and impact resistance in some cases. Besides, the decrease in compatibility would allow the physical property derived from the additional dihydroxy compound forming part of the copolymer to prevail and prevent the resulting polycarbonate resin composition from exhibiting its desired physical property.

<<3>> Method of Producing Carbonate Copolymer

A carbonate copolymer for use in the present invention may be produced by a general polymerization method, which may be either interface polymerization using carbonyl chloride or melt polymerization that induces transesterification with respect to diester carbonate. It is recommended, however, to adopt the melt polymerization that allows the dihydroxy compound to react to diester carbonate having less toxicity to the environment under the presence of a polymerization catalyst.

The carbonate copolymer for use in the present invention is more suitably obtained by the melt polymerization that induces transesterification between the dihydroxy compound and diester carbonate.

<Diester Carbonate>

Diester carbonate for use in the present invention may generally be the compound expressed by the following Formula (1). Only one of these diester carbonate compounds may be used alone. Alternatively, two or more of the diester carbonate compounds may be mixed together.

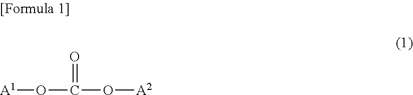

In Formula (1), A¹ and A² are substituted or non-substituted aliphatic groups having a carbon number of 1 to 18 or substituted or non-substituted aromatic groups independently of each other.

Examples of the diester carbonate expressed by Formula (1) include substituted diphenyl carbonates such as diphenyl carbonate and ditolyl carbonate, dimethyl carbonate, diethyl carbonate, and di-t-butyl carbonate. The diester carbonate is suitably either diphenyl carbonate or substituted diphenyl carbonate, and more suitably diphenyl carbonate. The diester carbonate may include an impurity such as a chloride ion and may inhibit the polymerization reaction or deteriorate the hue of the resulting carbonate copolymer in some cases. Thus, the diester carbonate is suitably a refined (e.g., distilled) one depending on the necessity.

The diester carbonate is suitably used at a molar ratio of 0.96 to 1.10, more suitably at a molar ratio of 0.98 to 1.04, with respect to all dihydroxy compounds used for the melt polymerization. If this molar ratio were less than 0.96, the number of terminal hydroxyl groups of the resultant carbonate copolymer would increase so much as to affect the thermal stability of the polymer. However, if the molar ratio were greater than 1.10, then the transesterification rate would decrease too much under the same condition to produce the carbonate copolymer at a desired molecular weight easily. In addition, in that case, an increased amount of diester carbonate would remain in the polycarbonate resin produced to emit an odor either during the molding process or out of the molded product, which is not beneficial.

<Transesterification Catalyst>

To obtain a carbonate copolymer for use in the present invention, a polycarbonate resin is made by causing transesterification between a dihydroxy compound including the dihydroxy compound of the present invention and the diester carbonate expressed by Formula (1) as described above. More specifically, the carbonate copolymer is obtained by causing the transesterification such that mono-hydroxy compounds produced as side products are removed out of the system. In this case, the melt polymerization is generally produced by causing the transesterification under the presence of a transesterification catalyst.

Any transesterification catalyst (which will be hereinafter sometimes referred to as a “catalyst” simply) may be used during the manufacturing process of the carbonate copolymer as long as the resultant carbonate copolymer has a high impact resistance, a low brittle fracture rate, a high surface hardness, and a good balance between the glass transition temperature and the impact resistance. Examples of suitable transesterification catalysts include Group I metal compounds, Group II metal compounds, and various basic compounds such as basic boron compounds, basic phosphorus compounds, basic ammonium compounds, and amine-based compounds in the long periodic table (see Nomenclature of Inorganic Chemistry IUPAC Recommendations 2005). It is recommended that Group I metal compounds and/or Group II metal compounds be adopted, among these compounds.

Optionally, it is possible to use any suitable basic compound such as a basic boron compound, a basic phosphorus compound, a basic ammonium compound, or an amine compound as a supplement to the Group I metal compound and/or Group II metal compound. Still, it is recommended that the Group I metal compound and/or Group II metal compound be used alone.

Also, the Group I metal compound and/or Group II metal compound are/is normally used in the form of a hydroxide or a salt such as a carbonate, a carboxylate, or a phenolate. Considering their availability and the easiness of their handling, hydroxides, carbonates, and acetates are suitably adopted, and acetates are more suitably used in view of their hue and polymerization activity.

Examples of the Group I metal compounds include sodium hydroxide, potassium hydroxide, lithium hydroxide, cesium hydroxide, sodium hydrogen carbonate, potassium hydrogen carbonate, lithium hydrogen carbonate, cesium hydrogen carbonate, sodium carbonate, potassium carbonate, lithium carbonate, cesium carbonate, sodium acetate, potassium acetate, lithium acetate, cesium acetate, sodium stearate, potassium stearate, lithium stearate, cesium stearate, sodium borohydride, potassium borohydride, lithium borohydride, cesium borohydride, sodium tetraphenyl borate, potassium tetraphenyl borate, lithium tetraphenyl borate, cesium tetraphenyl borate, sodium benzoate, potassium benzoate, lithium benzoate, cesium benzoate, disodium hydrogen phosphate, dipotassium hydrogen phosphate, dilithium hydrogen phosphate, dicesium hydrogen phosphate, disodium phenyl phosphate, dipotassium phenyl phosphate, dilithium phenyl phosphate, dicesium phenyl phosphate, alcoholates and phenolates of sodium, potassium, lithium, and cesium, and disodium, dipotassium, dilithium and dicesium salts of bisphenol A. Among other things, cesium compounds and lithium compounds are suitably used.

Examples of the Group II metal compounds include calcium hydroxide, barium hydroxide, magnesium hydroxide, strontium hydroxide, calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate, and strontium stearate. Among other things, magnesium compounds, calcium compounds, and barium compounds are suitably used, and magnesium compounds and/or calcium compounds are more suitably used.

Any one of the catalysts described above may be used alone. Alternatively, two or more of them may be used in combination as well.

If the catalyst used is a Group I metal compound and/or a Group II metal compound, the amount of the catalyst used and converted into the amount of the metal generally falls within the range of 0.1 to 100 μmol, suitably within the range of 0.5 to 50 μmol, and more suitably within the range of 1 to 25 μmol, with respect to one mole of every dihydroxy compound used for polymerization. If the catalyst used were too little, the polymerization reaction would not be activated enough to make a polycarbonate resin in a desired molecular weight or produce sufficient fracture energy. On the other hand, if the catalyst used were too much, not only the hue of the resulting polycarbonate resin would deteriorate but also some byproducts would be produced to cause a decrease in flowability and produce a gel more frequently. This may sometimes cause a brittle fracture and make it difficult to produce a polycarbonate resin of a target quality.

<Melt Polymerization>

As described above, a carbonate copolymer is obtained by melting and polymerizing together a dihydroxy compound, including a dihydroxy compound according to the present invention, and a diester carbonate via transesterification. The dihydroxy compound and the diester carbonate that are the materials of the carbonate copolymer are suitably mixed uniformly together before being subjected to the transesterification.

The temperature of the materials being mixed is generally at least equal to 80° C. and suitably 90° C. or more. The upper limit of the temperature is generally at most equal to 250° C., suitably 200° C. or less, and more suitably 150° C. or less. Among other things, the temperature particularly suitably falls within the range of 100° C. to 120° C. If the mixing temperature were too low, then the rate of solution could be too low or the solubility could be insufficient, thus often resulting in solidification and other inconveniences. However, if the mixing temperature were too high, then the dihydroxy compound could be degraded thermally in some cases, and the resultant polycarbonate resin could have its hue deteriorated and its light resistance affected adversely.

If the diester carbonate has a lower melting point than any of the dihydroxy compounds, the dihydroxy compound in solid or liquid state is suitably dissolved in the melt of the diester carbonate, because the dihydroxy compound will be soluble uniformly with its thermal degradation reduced.

The carbonate copolymer is suitably produced by going through the melt polymerization in multiple stages under the presence of a catalyst using a plurality of reactors. The melt polymerization is performed in a plurality of reactors for the following reasons. Specifically, during an initial stage of the melt polymerization, the dihydroxy compound and diester carbonate included in the reaction mixture are so much that it is important to suppress the vaporization of the dihydroxy compound and diester carbonate while maintaining a required polymerization rate. On the other hand, during a late stage of the melt polymerization, in order to shift the equilibrium toward polymerization, it is important to sufficiently distill away the mono-hydroxy compounds produced as side-products. As can be seen, to set multiple different polymerization reaction conditions, it is recommended, from the standpoint of productivity improvement, that a plurality of reactors arranged in series be used with their reaction conditions varied.

As for the number of reactors to use, at least two reactors may be used as described above. To improve the productivity and other factors, the number of reactors to use is at least three, suitably three to five, and typically four. As long as at least two reactors are used, each of those reactors may either have multiple reaction stages with mutually different conditions or change their temperature and pressure continuously, for example.

The catalyst may be either added to the material preparing vessel or material reservoir or added directly to the reactors. From the standpoints of the stability of supply and control of the melt polymerization, a catalyst supply line may be disposed halfway through a line of the materials yet to be supplied to the reactors, and the materials are suitably supplied in the form of an aqueous solution. The transesterification temperature should not be too low, because such a temperature would lead to a decline in productivity and an increase in the thermal history of the product. Nevertheless, the transesterification temperature should not be too high, either, because such a temperature would not only cause the vaporization of the dihydroxy compound and diester carbonate but also promote the decomposition and coloring of the polycarbonate resin as well.

The transesterification of the dihydroxy compound including at least isosorbide and the diester carbonate under the presence of a catalyst is generally carried out as a multi-stage process consisting of two or more stages. Specifically, during the first stage, the transesterification temperature (hereinafter sometimes referred to as an “internal temperature”) is normally in the range of 140 to 220° C., suitably in the range of 150 to 200° C., and the residence time is normally in the range of 0.1 to 10 hours, suitably in the range of 0.5 to 3 hours. From the second stage and on, the transesterification is carried out at an increased temperature normally falling within the range of 210 to 270° C., and the pressure on the reaction system is gradually lowered from the pressure during the first stage with the phenol produced simultaneously removed out of the reaction system such that polymerization and condensation reactions are ultimately carried out at a pressure of 200 Pa or less applied to the reaction system. If the transesterification temperature were excessively high, the hue would deteriorate when the materials are formed into a molded product, thus possibly increasing the chances of brittle fracture. However, if the transesterification temperature were too low, then the target molecular weight would not rise, the molecular weight distribution would become too broad, the impact resistance would be insufficient, and the ratio of brittle fracture could be too high in some cases. Furthermore, if the residence time of the transesterification were too long, then the brittle fracture ratio would tend to increase. However, if the residence time were too short, then the target molecular weight would not rise and the impact resistance could be insufficient in some cases.

Particularly, to obtain a good carbonate copolymer having a high surface impact strength and a low brittle fracture ratio with the coloring, thermal degradation or scorching thereof minimized, the maximum internal temperature on every reaction stage is suitably lower than 255° C., and particularly falls within the range of 225 to 250° C. To prevent the polymerization rate from dropping significantly during the second half of the polymerization reaction and to minimize the thermal degradation of the carbonate copolymer due to the thermal history, a horizontal reactor having good plug flowability and surface renewability is suitably used during the last stage of the reaction.

Also, to allow the carbonate copolymer to have a high surface impact strength and a high molecular weight, the polymerization temperature and polymerization time are sometimes increased as much as possible. In that case, however, the carbonate copolymer may come to have some foreign substances or get scorched, and tend to cause a brittle fracture. Thus, to increase the surface impact strength and reduce the brittle fracture at the same time, a highly active catalyst is suitably used and/or the pressure of the reaction system is suitably set properly such that the polymerization temperature is lowered and that the polymerization time is shortened. In addition, to reduce the brittle fracture, the foreign substances, scorching, and other unwanted factors that have been caused in the reaction system either in the middle, or during the last stage, of the reaction are suitably removed with a filter, for example.

To prevent the carbonate copolymer for use in the present invention from getting colored while the copolymer is being produced by melt polymerization, one or more phosphoric acid compounds or phosphorous acid compounds may be added during the polymerization.

As the phosphoric acid compound, one or more trialkyl phosphates such as trimethyl phosphite and triethyl phosphite is/are suitably used. These phosphoric acid compounds added suitably account for 0.0001 mol % to 0.005 mol %, and more suitably 0.0003 mol % to 0.003 mol %, with respect to all hydroxy compound components. If the phosphoric acid compounds added were below the lower limit, the coloring phenomenon would be reduced much less effectively. However, if the phosphoric acid compounds added were above the upper limit, then the transparency would decrease, the coloring phenomenon would rather be promoted, or the thermal resistance would decline.

As the phosphorous acid compound, any one or more thermal stabilizers may be selectively used from the group consisting of trimethyl phosphite, triethyl phosphite, tris(nonylphenyl) phosphite, trimethyl phosphate, tris(2,4-di-t-butylphenyl) phosphite, and bis(2,4-di-t-butylphenyl) pentaerythritol diphosphite. These phosphorous acid compounds added suitably account for 0.0001 mol % to 0.005 mol %, and more suitably 0.0003 mol % to 0.003 mol %, with respect to all hydroxy compound components. If the phosphorous acid compounds added were below the lower limit, the coloring phenomenon would be reduced much less effectively. However, if the phosphorous acid compounds added were above the upper limit, then the transparency would decrease, the coloring phenomenon would rather be promoted, or the thermal resistance would decline.

The phosphoric acid compound and the phosphorous acid compound may be added in combination. In that case, the amount added is the sum of the amounts of the phosphoric acid and phosphorous acid compounds added, and is also suitably in the range of 0.0001 mol % to 0.005 mol %, and more suitably 0.0003 mol % to 0.003 mol %, with respect to all hydroxy compound components as described above. If their amount added were below the lower limit, the coloring phenomenon would be reduced much less effectively. However, if their amount added were above the upper limit, then the transparency would decrease, the coloring phenomenon would rather be promoted, or the thermal resistance would decline.

After having been subjected to the melt polymerization as described above, the carbonate copolymer is usually cooled and solidified, and then pelleted with a rotary cutter, for example

Any arbitrary pelleting method may be adopted. For example, any of the following methods may be used. Specifically, the carbonate copolymer in a molten state may be removed from the last polymerization reactor, and then cooled and solidified in the form of strands such that the carbonate copolymer thus solidified is pelleted. Alternatively, the resin in a molten state may be supplied from the last polymerization reactor to a uniaxial or biaxial extruder so as to be extruded in the molten state, and then cooled and solidified such that the carbonate copolymer thus solidified is pelleted. Still alternatively, the carbonate copolymer in a molten state may be removed from the last polymerization reactor, and cooled and solidified in the form of strands such that the carbonate copolymer thus solidified is pelleted once. After that, the resin may be supplied again to a uniaxial or biaxial extruder, extruded in a molten state, and then cooled and solidified such that the carbonate copolymer thus solidified is pelleted.

During this process, in the extruder, the diester carbonate and mono-hydroxy compounds remaining there may be devolatilized under a reduced pressure, and/or any agent selected from the group consisting of generally known thermal stabilizers, neutralizers, ultraviolet absorbers, mold release agents, colorants, antistatic agents, slip additives, lubricants, plasticizers, compatibilizers, and flame retardants may also be added and kneaded together.

The temperature of the melt kneading process to be performed in the extruder varies depending on the glass transition temperature and molecular weight of the carbonate copolymer, but normally falls within the range of 150 to 300° C., suitably within the range of 200 to 270° C., and more suitably within the range of 230 to 260° C. If the melt kneading temperature were lower than 150° C., then the polycarbonate resin would have so high melt viscosity as to impose too heavy load on the extruder to avoid a decline in productivity. However, if the melt kneading temperature were higher than 300° C., then the polycarbonate resin would be thermally degraded so significantly that foreign substances would enter the resin or the resin would get scorched. Thus, to eliminate such foreign substances or scorching, it is recommended that a filter be disposed either in the extruder or at the outlet of the extruder.

The filter normally has a sieve opening size of at most 400 μm, suitably 200 μm or less, and more suitably 100 μm or less. If the sieve opening size of the filter were too large, then the foreign substances and/or the scorched portions could not be eliminated completely, and a brittle fracture could be caused when the carbonate copolymer or a composition thereof is formed.

Optionally, a plurality of filters may be arranged and used in series. Or a filter device in which a plurality of leaf-disk polymer filters are stacked one upon the other may also be used.

While the carbonate copolymer or a composition thereof is cooled and turned into a chip, some cooling method such as air cooling or water cooling is suitably adopted. The air for use in the air cooling has suitably had foreign substances filtered out in advance by an HEPA filter (suitably a filter defined by JIS Z8112) in order to prevent the foreign substances in the air from being deposited again. If water cooling is adopted, water that has had metallic components thereof removed by an ion exchange resin, for example, and that has had foreign substances filtered out by a filter is suitably used. Any of filters with various sieve opening sizes may be used. Among those filters, a filter with a sieve opening size of 10 to 0.45 μm is suitably used.

<Physical Properties of Carbonate Copolymer>

The copolymerization composition of the carbonate copolymer for use in the present invention may be obtained by cooling the molten and mixed polycarbonate resin to turn it into chips, dissolving the chips in a predetermined amount of deuterated chloroform solvent, and then measuring the resultant mixture with a ¹-NMR.

The glass transition temperature of the carbonate copolymer for use in the present invention varies depending on its composition, but is suitably at least equal to 60° C., more suitably 75° C. or higher. If the glass transition temperature is higher than the lower limit value, the polycarbonate resin composition of the present invention tends to exhibit good thermal resistance and a sufficient degree of moldability. On the other hand, the glass transition temperature of the carbonate copolymer for use in the present invention is suitably at most equal to 155° C., more suitably 145° C. or less. If the glass transition temperature were higher than this upper limit value, then the melt viscosity during the polymerization and molding would be too high to increase the molecular weight sufficiently during the polymerization or to melt and mix the resin composition sufficiently during the molding process. As a result, its impact resistance property would tend to decline.

<<4>> Method of Producing Polycarbonate Resin Composition

<Melting and Mixing Carbonate Copolymer>

A polycarbonate resin composition according to the present invention may be produced by melting and mixing together a plurality of carbonate copolymers that have been obtained by the melt polymerization process to have mutually different copolymerization ratios.

Any of various known methods may be adopted as a method of melting and mixing together those carbonate copolymers. For example, according to a suitable method, a plurality of carbonate copolymers with mutually different compositions may be supplied to an extruder and then mixed and kneaded together there.

A polycarbonate resin composition according to the present invention may include, depending on the necessity, any of the following additives unless the advantages of the present invention are ruined.

(Elastomeric Polymer)

A polycarbonate resin according to the present invention may be used to make an automotive part. In that case, further addition of an elastomeric polymer to the polycarbonate resin imparts impact resistance to the resin and provides a part that ensures an increased degree of safety against impact.

Such an elastomeric polymer may be a graft copolymer obtained by copolymerizing either natural rubber or a rubber component with a glass transition temperature of 10° C. or less and one or more monomers selected from the group consisting of aromatic vinyl, vinyl cyanide, acrylic esters, methacrylic esters, and vinyl compounds that can be copolymerized with these. A more suitable elastomeric polymer is a core-shell graft copolymer in which one or more shells of these monomers are graft-copolymerized with a core of a rubber component.

Alternatively, a block copolymer including such a rubber component and any of these monomers may also be used. Specific examples of those block copolymers include thermoplastic elastomers such as styrene-ethylene propylene-styrene elastomer (hydrogenated styrene-isoprene-styrene elastomer) and hydrogenated styrene-butadiene-styrene elastomer. Still alternatively, any of various types of elastomeric polymers known as other thermoplastic elastomers, such as a polyurethane elastomer, a polyester elastomer, and a polyether amide elastomer, may also be used.

If the elastomeric polymer is used as an impact modifier, the core-shell graft copolymer is used more suitably. In the core-shell graft copolymer, the particle size of its core represented by the weight average particle size is suitably in the range of 0.05 to 0.8 μm, more suitably in the range of 0.1 to 0.6 μm, and even more suitably in the range of 0.1 to 0.5 μm. If the particle size falls within the range of 0.05 to 0.8 μm, even better impact resistance will be achieved. The elastomeric polymer suitably includes 40% or more of the rubber component, and more suitably includes 60% or more of the rubber component.

Examples of the rubber component include butadiene rubber, butadiene-acrylic composite rubber, acrylic rubber, acrylic-silicone composite rubber, isobutylene-silicone composite rubber, isoprene rubber, styrene-butadiene rubber, chloroprene rubber, ethylene-propylene rubber, nitrile rubber, ethylene-acrylic rubber, silicone rubber, epichlorohydrin rubber, fluorine rubber, and these rubbers with their unsaturated bonds including hydrogen as an additive. Considering that toxic chemical substances could be emitted when the rubber component is burned, a rubber component including no halogen atoms is beneficial in terms of its environmental load.

The rubber component suitably has a glass transition temperature of −10° C. or less, more suitably −30° C. or less. As the rubber component, butadiene rubber, butadiene-acrylic composite rubber, acrylic rubber, or acrylic-silicone composite rubber, in particular, is suitably used. As used herein, the “composite rubber” refers to either rubber in which two types of rubber components are copolymerized together or rubber having an IPN structure in which those two rubber components are intertwined together and inseparable from each other.

Optionally, the rubber component may be copolymerized with a vinyl compound. The vinyl compound may be an aromatic vinyl compound or acrylic ester, for example. Examples of the aromatic vinyl include styrene, α-methyl styrene, p-methyl styrene, alkoxy styrene, and halogenated styrene. Among other things, styrene is particularly suitable. Examples of the acrylic ester include methyl acrylate, ethyl acrylate, butyl acrylate, cyclohexyl acrylate, and octyl acrylate. Examples of the methacrylic ester include methyl methacrylate, ethyl methacrylate, butyl methacrylate, cyclohexyl methacrylate, and octyl methacrylate. Among other things, methyl methacrylate is particularly suitable. In particular, it is recommended that the rubber component include, as its essential component, a methacrylic ester such as methyl methacrylate. More particularly, the methacrylic ester suitably accounts for 10% by weight or more, more suitably 15% by weight or more, of the graft component as 100% by weight (or shell as 100% by mass in a core-shell polymer).

The elastomeric polymer including the rubber component may be produced by any of bulk polymerization, solution polymerization, suspension polymerization, or emulsion polymerization. There is no problem no matter whether the copolymerization method is a single-stage graft or a multi-stage graft. Alternatively, the elastomeric polymer may also be a mixture of copolymers, each consisting essentially of graft components that are produced as side products during the manufacturing process. Furthermore, examples of the polymerization methods include not only the general emulsion polymerization but also a soap-free polymerization method that uses an initiator such as potassium persulfate, a seed polymerization method, and a two-stage swelling polymerization method. Still alternatively, in the suspension polymerization method, a water phase and a monomer phase may be held independently of each other and accurately supplied to a continuous distributor such that their particle sizes are controlled by the number of revolutions of the distributor. Yet alternatively, in the continuous manufacturing process, in an aqueous liquid with dispersion power, the monomer phase may be supplied and have its particle size controlled by being passed through either an orifice or porous filter with as small a diameter as a few μm to several ten μm. In the case of the core-shell graft polymer, the reaction of the core and shell may be either a single-stage one or a multi-stage one.

Such elastomeric polymers are on public sale and easily available. Examples of rubber components including, as their main ingredient, butadiene rubber, acrylic rubber or butadiene-acrylic composite rubber include: Kane Ace B series (e.g., B-56) manufactured by Kaneka Corporation; METABLEN C series (e.g., C-223A) and W series (e.g., W-450A) manufactured by Mitsubishi Rayon Co., Ltd.; Paraloid EXL series (e.g., EXL-2602), HIA series (e.g., HIA-15), BTA series (e.g., BTA-III), and KCA series manufactured by Kureha Corporation; Paraloid EXL series and KM series (e.g., KM-336P and KM-357P) manufactured by Rohm and Haas Company; and UCL Modifier Resin series (UMG AXS resin series) manufactured by Ube Cycon, Ltd. (currently known as UMG ABS, Ltd.). Examples of rubber components including, as their main ingredient, acrylic-silicone composite rubber include products available under the trade names METABLEN S-2001 and SRK-200 from Mitsubishi Rayon Co., Ltd.

If the sum of the multiple different carbonate copolymers included in a polycarbonate resin composition for use in the present invention is 100 parts by weight, the content of the elastomeric polymer is suitably in the range of 0.2 to 50 parts by weight, more suitably in the range of 1 to 30 parts by weight, and even more suitably in the range of 1.5 to 20 parts by weight. This composition range would impart good impact resistance to the composition while allowing the rigidity to decrease much less steeply.

(Thermal Stabilizer)

According to the present invention, one or more thermal stabilizers may be added to the plurality of carbonate copolymers being melted and mixed together in order to substantially avoid coloring due to deterioration of the carbonate copolymers.

As such a thermal stabilizer, any of phosphorous acid, phosphoric acid, phosphonous acid, phosphonic acid, or their esters may be used. Specific examples of the thermal stabilizer include trimethyl phosphite, triethyl phosphite, triphenyl phosphite, tris(nonylphenyl) phosphite, tris(2,4-di-t-butylphenyl) phosphite, tridecyl phosphite, trioctyl phosphite, trioctadecyl phosphite, didecyl monophenyl phosphite, dioctyl monophenyl phosphite, diisopropyl monophenyl phosphite, monobutyl diphenyl phosphite, monodecyl diphenyl phosphite, monooctyl diphenyl phosphite, bis(2,6-di-t-butyl-4-methylphenyl) pentaerythritol diphosphite, 2,2-methylene bis(4,6-di-t-butylphenyl) octyl phosphite, bis(nonylphenyl) pentaerythritol diphosphite, bis(2,4-di-t-butylphenyl) pentaerythritol diphosphite, distearyl pentaerythritol diphosphite, tributyl phosphate, triethyl phosphate, trimethyl phosphate, triphenyl phosphate, diphenyl monoorthoxenyl phosphate, dibutyl phosphate, dioctyl phosphate, diisopropyl phosphate, 4,4′-biphenylene diphosphinate tetrakis (2,4-di-t-butylphenyl), dimethyl benzene phosphonate, diethyl benzene phosphonate, and dipropyl benzene phosphonate. Among other things, tris(nonylphenyl) phosphite, trimethyl phosphate, tris(2,4-di-t-butylphenyl) phosphite, bis(2,4-di-t-butyl-phenyl) pentaerythritol diphosphite, bis(2,6-di-t-butyl-4-methylphenyl) pentaerythritol diphosphite, and dimethyl benzene phosphonate are suitably used.

An amount of the thermal stabilizer may be further added even after the thermal stabilizer has been added during the melt polymerization. Specifically, a phosphorous acid compound may be added by the mixing method to be described later after a polycarbonate resin has been obtained with an appropriate amount of a phosphorous or phosphoric acid compound added. This allows addition of an even larger amount of the thermal stabilizer with a decrease in transparency or thermal resistance minimized and with coloring avoided during the polymerization, thus substantially preventing the hue from deteriorating.

The content of any of these thermal stabilizers relative to 100 parts by mass of the polycarbonate resin is suitably in the range of 0.0001 to 1.0 part by mass, more suitably in the range of 0.0005 to 0.5 parts by mass, and even more suitably in the range of 0.001 to 0.2 parts by mass.

(Antioxidant)

Optionally, one or more generally known antioxidants may be added to the polycarbonate resin composition according to the present invention for the purpose of anti-oxidation.

Examples of such antioxidants include pentaerythritol tetrakis (3-mercapto propionate), pentaerythritol tetrakis (3-laurylthio propionate), glycerol-3-stearyl thio propionate, triethylene glycol-bis[3-(3-t-butyl-5-methyl-4-hydroxyphenyl) propionate], 1,6-hexanediol-bis[3-(3,5-di-t-butyl-4-hydroxy phenyl) propionate], pentaerythritol-tetrakis [3-(3,5-di-t-butyl-4-hydroxyphenyl) propionate], octadecyl-3-(3, 5-di-t-butyl-4-hydroxyphenyl) propionate, 1,3,5-trimethyl-2,4,6-tris(3,5-di-t-butyl-4-hydroxybenzyl) benzene, N,N-hexamethylene bis(3,5-di-t-butyl-4-hydroxy-hydro cinnamic amide), 3,5-di-t-butyl-4-hydroxy-benzyl phosphonate-diethyl ester, tris(3,5-di-t-butyl-4-hydroxybenzyl) isocyanurate, 4,4′-biphenylene diphosphinate tetrakis (2,4-di-t-butylphenyl), and 3,9-bis {1,1-dimethyl-2-[β-(3-t-butyl-4-hydroxy-5-methylphenyl) propionyloxy] ethyl}-2,4,8,10-tetraoxaspiro (5,5) undecane.

The content of any of these antioxidants added relative to 100 parts by mass of polycarbonate resin is suitably in the range of 0.0001 to 0.5 parts by mass.

(Mold Release Agent)

Optionally, one or more mold release agents may be added to the polycarbonate resin composition according to the present invention in order to facilitate the release of the resin composition from the chill roller during a sheet forming process or from the die during an injection molding process, unless the advantages of the present invention are ruined.

Examples of such mold release agents include monohydric or polyhydric alcohol higher fatty acid esters, higher fatty acids, paraffin waxes, beeswaxes, olefin waxes, olefin waxes containing a carboxyl group and/or a carboxylic acid anhydride group, silicone oil, and organopolysiloxane.

As the higher fatty acid ester, a partial or complete ester including monohydric or polyhydric alcohol having a carbon number of 1 to 20 and a saturated fatty acid having a carbon number of 10 to 30 is suitably used. Examples of such a partial or complete ester including monohydric or polyhydric alcohol and a saturated fatty acid include stearic acid monoglyceride, stearic acid diglyceride, stearic acid triglyceride, stearic acid monosorbitate, stearic acid stearyl, behenic acid monoglyceride, behenic acid behenyl, pentaerythritol monostearate, pentaerythritol tetrastearate, pentaerythritol tetrapelargonate, propyleneglycol monostearate, stearyl stearate, palmityl palmitate, butyl stearate, methyl laurate, isopropyl palmitate, biphenyl biphenate, sorbitan monostearate, and 2-ethylhexyl stearate. Among other things, monoglyceride stearate, triglyceride stearate, pentaerythritol tetrastearate, and behenic acid behenyl are suitably used.

The higher fatty acid is suitably a saturated fatty acid having a carbon number of 10 to 30. Examples of such fatty acids include myristic acid, lauric acid, palmitic acid, stearic acid, and behenic acid.

The content of such a mold release agent relative to 100 parts by mass of the polycarbonate resin is suitably in the range of 0.01 to 5 parts by mass.

(Ultraviolet Absorber, Light Stabilizer)

Even when exposed to an ultraviolet ray, the polycarbonate resin composition according to the present invention will discolor much less significantly than a conventional polycarbonate resin does. To further improve its effect, one or more ultraviolet absorbers or light stabilizers may be added thereto, unless the advantages of the present invention are ruined.

Examples of such ultraviolet absorbers and light stabilizers include 2-(2′-hydroxy-5′-t-octylphenyl) benzotriazole, 2-(3-t-butyl-5-methyl-2-hydroxyphenyl)-5-chloro benzotriazole, 2-(5-methyl-2-hydroxyphenyl) benzotriazole, 2-[2-hydroxy-3,5-bis(α,α-dimethylbenzyl) phenyl]-2H-benzotriazole, 2,2′-methylene bis(4-cumyl-6-benzotriazole phenyl), and 2,2′-p-phenylene bis 3-benzoxazine-4-on).

The content of such an ultraviolet absorber or light stabilizer relative to 100 parts by mass of the polycarbonate resin is suitably in the range of 0.01 to 2 parts by mass.

(Colorant)

A resin composition for use in the present invention may include a colorant. As such a colorant, an inorganic pigment or an organic dye/pigment such as an organic pigment or an organic dye may be used.

Examples of inorganic pigments include: chromates such as barium yellow (C. I. pigment Yellow 31), chrome yellow (C. I. pigment Yellow 34), zinc yellow (C. I. pigment Yellow 36), nickel titanium yellow (C. I. pigment Yellow 53), and chromium titanium yellow (C. I. pigment Brown 24); ferrocyanides such as Prussian blue (C. I. pigment Blue 27); sulfides such as cadmium yellow (C. I. pigment Yellow 42) and cadmium red (C. I. pigment Red 108); oxides such as iron black (C. I. pigment Black 11), red iron oxide (C. I. pigment Red 101), and titanium dioxide (C. I. pigment White 6); silicates such as ultramarine (C. I. pigment Blue 29); and carbon blacks (C. I. pigment Black 7) such as channel black, roller black, disk, gas furnace black, oil furnace black, thermal black, and acetylene black.

Examples of organic dyes/pigments such as organic pigments and organic dyes include C. condensation aniline), I. pigment Yellow 12 (monoazo), pigment Yellow 23 (anthraquinone), I. pigment Yellow 109 (isoindolinone), I. pigment Yellow 138 (quinophthalone), I. pigment Orange 5 (monoazo), I. Vat Orange 3 (perinone), I. pigment Red 1 (monoazo), I. pigment Red 37 (pyrazoloneazo), I. pigment Red 87 (thioindigo), I. pigment Red 224 (perylene), I. pigment Violet 19 (quinacridone), I. pigment Violet 3 (azomethine), pigment Violet 37 (dioxazine), I. pigment Blue 15 (phthalocyanine), and C. I. pigment Green 1 (azomethine).

One of these colorants may be used alone, or two or more of them may be used in combination.

The content of the colorant for use in the present invention relative to 100 parts by weight of the polycarbonate resin may be in the range of 0.00001 to 3 parts by weight, and suitably in the range of 0.0001 to 2 parts by weight, more suitably 0.0005 to 1 part by weight. If the content of the colorant were less than 0.00001 parts by weight, it would be difficult to display a deep and clarifying tint. Also, if the content of the colorant were more than 3 parts by weight, then the molded product would have too high surface roughness to display a deep and clarifying tint easily.

(Other Additives)

Furthermore, a polycarbonate resin composition according to the present invention may also be a resin composition including any of the additives described above. Optionally, the resin composition may further include any of various other known additives such as an impact modifier, a flame retardant, a flame retardant promoter, a hydrolysis inhibitor, an antistatic agent, a foaming agent, or a dye/pigment, unless the advantages of the present invention are ruined. Alternatively, the resin composition may also include a synthetic resin such as aromatic polycarbonate, aromatic polyester, polyamide, polystyrene, polyolefin, acrylic, or amorphous polyolefin, or a biodegradable resin such as polylactic acid or polybutylene succinate.

(Blending Additives)

In a polycarbonate resin composition according to the present invention, the carbonate copolymer and various types of additives or other components described above may be blended together by a method in which they are mixed and kneaded together with a tumbler, a V-blender, a super mixer, a Nauta mixer, a Banbury mixer, a kneading roll, or an extruder, or by a solution blending method in which they are mixed together while being dissolved in a common good solvent such as methylene chloride. However, the present invention is not limited to any particular blending method, but any of various general blending methods may be adopted arbitrarily.

Furthermore, the carbonate copolymer and the various additives or other components may be blended together at any arbitrary timing. Specifically, for example, the various additives and other components may be added after a plurality of carbonate copolymers with mutually different compositions have been mixed together and pelleted. Alternatively, the various additives and other components may be added to each of the plurality of carbonate copolymers with mutually different compositions to obtain composition pellets, which may be then mixed together. Still alternatively, the various additives and other components may be added to a plurality of carbonate copolymers with mutually different compositions while these carbonate copolymers are being mixed together.

<<5>> Molding Polycarbonate Resin Composition

<Molding>

The carbonate copolymers for use to make a polycarbonate resin composition according to the present invention may be formed in the following manner Specifically, a plurality of carbonate copolymers with mutually different compositions may be mixed together, various additives and other components are added thereto, and then the mixture is once pelleted either directly or through a melt extruder. After that, the pellets thus obtained may be formed by a generally known process such as injection molding, extrusion, or compression. Among other things, injection molding is applicable particularly effectively to the resin composition of the present invention.

The molded product may be an injection molded product, for example. Specifically, the molding process may be performed in the following manner. For example, a plurality of carbonate copolymers and additives and other materials (if necessary) may be directly mixed together, put into either an extruder or an injection molding machine, and then molded together. Alternatively, according to another method, the materials may be melted and mixed together through a biaxial extruder and then extruded into strand shapes to obtain pellets. After that, those pellets may be molded by being put into either an extruder or an injection molding machine. According to any of these two methods, a decrease in molecular weight due to the hydrolysis of the polycarbonate resin needs to be taken into account. To obtain a uniform mixture, it is recommended that the latter method be adopted. Thus, the latter method will be described below.

The carbonate copolymers and the additives (if necessary) are sufficiently dried to vaporize their water. After that, they are melted and mixed together with a uniaxial or biaxial extruder, and extruded into strand shapes to obtain pellets. In this process step, the melt extrusion temperature is suitably appropriately selected with a possible variation in viscosity due to the compositions or the blending ratios of the respective carbonate copolymers taken into account. Specifically, the molding temperature is suitably in the range of 200° C. to 260° C., more suitably in the range of 210° C. to 250° C., and even more suitably in the range of 220° C. to 240° C.

The pellets obtained by this method may be sufficiently dried to vaporize their water, and then may be molded into the form of a film, a plate or an injection molded product by the following method. The water may be vaporized by any appropriate combination of known methods including a reduced-pressure drying process in which the objects to be dried are loaded into a hermetic container, which is then evacuated with a vacuum pump, a heated drying method that uses a hopper dryer, and a method of drying pellets being transported using a drying gas with a low dew point.

The method of forming the injection molded product is not particularly limited.

For example, a general injection molding process for thermoplastic resin, a gas-assisted molding process, an injection compression molding process, or any other appropriate injection molding process may be adopted. Alternatively, depending on the intended purpose, any other molding method such as an in-molding method, a gas-press molding method, a two-color molding method or a sandwich molding method may also be adopted.

<Uses>

The molded product according to the present invention has so small a number of visual imperfections such as flow marks or weld lines and so good rigidity and impact resistance that the uses of the molded product of the present invention are not particularly limited. Examples of its uses include building materials, parts of electric and electronic devices, exterior automotive trim components, and various types of lenses such as lenses for cellphone cameras, and lenses for pickups for optical discs.

### Examples

(1) Measurement of Deflection Temperature Under Load

A pellet of a polycarbonate resin composition was dried at 80° C. for six hours with a hot air drier. Next, the pellet of the polycarbonate copolymer or resin composition thus dried was supplied to an injection molding machine (J75EII manufactured by the Japan Steel Works, Ltd.), thereby forming an ISO test piece to evaluate its mechanical and physical properties at a resin temperature of 240° C., a die temperature of 60° C., and a molding cycle time of 40 seconds. Then, the ISO test piece to evaluate the mechanical and physical properties thus obtained had its deflection temperature under load measured under a load of 1.80 MPa by a method complying with the ISO75 standard.

(2) Measurement of Charpy Impact Strength

The ISO test piece to evaluate the mechanical and physical properties obtained as described above was subjected to machining to make a test piece, of which the notch tip R was located at 0.75 mm. Then, the test piece was subjected to a notched Charpy impact test in compliance with the ISO 179 (2000). The higher this value is, the higher the impact resistance should be.

(3) Surface Impact Test

Pellets of a polycarbonate resin composition were dried at 80° C. for six hours with a hot air drier. Next, the pellets of the polycarbonate copolymers or resin composition thus dried were supplied to an injection molding machine (J75EII manufactured by the Japan Steel Works, Ltd.), thereby obtaining a flat plate with dimensions of 100 mm×100 mm×2 mmt at a resin temperature of 240° C., a die temperature of 60° C., and a molding cycle time of 40 seconds. The flat plate thus obtained was cooled for 10 minutes in an environment of −20° C., and then subjected to a surface impact test with a high-speed puncture impact tester Hydro-Shot HITS-P10 (manufactured by Shimadzu Corporation). The test was carried out with a stamping striker having a hemispherical tip with a diameter of 20 mm and a circular supporter with a diameter of 40 mm

### First Manufacturing Example

In a polymerization reactor including an impeller and a reflux condenser controlled at 100° C., prepared were isosorbide (ISB) (POLYSORB manufactured by Rocket Frères Sa.), cyclohexanedimethanol (CHDM) (manufactured by Eastman Chemical Company), diphenyl carbonate (DPC) (manufactured by Mitsubishi Chemical Corporation) that had been distilled and refined to have an ion chloride concentration of 10 ppb or less, and calcium acetate monohydrate such that these compounds would satisfy the molar ratio ISB/CHDM/DPC/calcium acetate monohydrate=0.70/0.30/1.00/1.3×10⁻⁶. These compounds were sufficiently replaced with nitrogen to have their oxygen concentration adjusted to the range of 0.0005 to 0.001 vol %. Next, these compounds were heated with a heating medium. When their inner temperature reached 100° C., they started to be stirred up such that the content would be melted and mixed uniformly while being controlled to keep an inner temperature of 100° C. Thereafter, the temperature started to be raised such that the inner temperature would reach 210° C. in 40 minutes. When the inner temperature reached 210° C., the pressure started to be reduced with control still carried on to keep this temperature. The pressure was reduced to 13.3 kPa (which is an absolute pressure; the same applies hereinafter) in 90 minutes since the temperature had reached 210° C. The temperature was kept for 60 more minutes with this pressure maintained.

The phenol vapor produced as a side product as a result of the polymerization reaction was guided to a reflux condenser that used, as a refrigerant, vapor, of which the temperature was controlled at 100° C. as the inlet temperature to the reflux condenser. Small amounts of dihydroxy compounds and diester carbonate included in the phenol vapor were supplied back to the polymerization reactor. Subsequently, the rest of the phenol vapor that had not condensed was guided to, and collected in, a condenser that used hot water at 45° C. as a refrigerant. The content that had been turned into an oligomer in this manner had its pressure raised to the atmospheric pressure once, and then transferred to another polymerization reactor including an impeller and a reflux condenser being controlled in the same way as described above. Then, the temperature started to be raised and the pressure started to be reduced such that the inner temperature would reach 220° C. and the pressure would reach 200 Pa in 60 minutes.

Thereafter, the inner temperature was further raised to 230° C. and the pressure was further reduced to 133 Pa or less in 20 minutes. When a predetermined agitation power was reached, the pressure was allowed to revert to the atmospheric pressure again. Then, the content was removed in the form of a strand, which was then cut out into pellets of the carbonate copolymer with a rotary cutter.

### Second Manufacturing Example

Pellets of the carbonate copolymer were obtained in the same way as in the first manufacturing example except that the respective compounds were prepared to have the composition ISB/CHDM/DPC/calcium acetate monohydrate=0.50/0.50/1.00/1.3×10⁻⁶.

Note that the compounds used in the following examples and comparative examples will be identified by the abbreviations of:
ISB: isosorbide (trade name POLYSORB manufactured by Rocket Frères Sa.)
CHDM: 1,4-cyclohexanedimethanol (manufactured by Eastman Chemical Company)
DPC: diphenyl carbonate (manufactured by Mitsubishi Chemical Corporation)

<Elastomeric Polymer>
EXL2690: MBS-based rubber (Paraloid EXL2690 manufactured by the Dow Chemical Company, Japan)

<Thermal Stabilizer>
AS2112: phosphite-based antioxidant (Adekastab 2112 manufactured by ADEKA Corporation)

<Antioxidant>
IRGANOX1010: phenol-based antioxidant (trade name IRGANOX1010 manufactured by BASF in Japan)

<Mold Release Agent>
E-275: glycol distearate (trade name Unistar E-275 manufactured by NOF Corporation)

### First Example

Using the pellets of the carbonate copolymer manufactured in the first and second manufacturing examples, the respective components were blended together to have the polycarbonate resin composition makeup shown in the following Table 1. Then, the mixture was extruded with a uniaxial extruder of 40 mmφ at a cylinder temperature of 250° C., cooled and solidified with water, and then pelleted with a rotary cutter, thereby producing a polycarbonate resin composition colored in black. The polycarbonate resin composition thus obtained had its deflection temperature under load (at 1.80 MPa) and notched Charpy impact strength (R=0.75) measured and evaluated by the methods described above. The results are shown in the following Table 1.

### Second Example

A polycarbonate resin composition was produced and evaluated in the same way as in the first example except that Paraloid EXL2690 was further used as an elastomeric polymer such that the polycarbonate resin composition would have the composition shown in the following Table 1. The results are shown in the following Table 1:

### First Comparative Example

A polycarbonate resin composition was produced and evaluated in the same way as in the first example except that pellets of the carbonate copolymer produced in the first manufacturing example were used. The results are shown in the following Table 1:

TABLE 1

| | | | Composition | Tg | Example | Example | Cmp. |
|---|---|---|---|---|---|---|---|
| | | | (mol %) | (° C.) | 1 | 2 | Ex. 1 |
| Polycarbonate | Polycarbonate | Manufacturing | ISB/CHDM = 70/30 | 121 | 25 | 23.75 | 100 |
| Resin | Resin | Example 1 | | | | | |
| Composition | Composition | Manufacturing | ISB/CHDM = 50/50 | 98 | 75 | 71.25 | — |
| Makeup | | Example 2 | | | | | |
| [mass %] | Elastomeric | EXL2690 | | | | 5 | |
| | Polymer | | | | | | |
| | Thermal | AS2112 | | | 0.05 | 0.05 | 0.05 |
| | Stabilizer | | | | | | |
| | Antioxidant | IRGANOX1010 | | | 0.1 | 0.1 | 0.1 |
| | Mold | E-275 | | | 0.3 | 0.3 | 0.3 |
| | Release agent | | | | | | |
| | Result of | | Notched Charpy | | 108 | 140 | 80 |
| | Evaluation | | Impact Strength | | | | |
| | | | (notch's R = 0.75) | | | | |
| | | | Surface Impact | | Ductile | Ductile | Brittle |
| | | | Test/Fracture | | | | |
| | | | State (at −23° C.) | | | | |

1. An interior/exterior automotive trim component of a polycarbonate resin composition obtained by melting and mixing together a plurality of carbonate copolymers with mutually different copolymerization ratios, wherein
each of the plurality of carbonate copolymers that form the polycarbonate resin composition is comprised of structural units derived from two or more different dihydroxy compounds,
the structural units derived from the dihydroxy compounds include a structural unit (ISB unit) derived from isosorbide and a structural unit (CHDM unit) derived from cyclohexane dimethanol,
in every one of the plurality of carbonate copolymers that form the polycarbonate resin composition, a molar ratio of the ISB unit to every dihydroxy compound unit in the carbonate copolymer is equal to or greater than 30 mol %, and
the molar ratio of the ISB unit to the CHDM unit in the polycarbonate resin composition satisfies the inequality:
53/47≦ISB unit/CHDM unit≦56/44.

2. The interior/exterior automotive trim component of claim 1, wherein
the polycarbonate resin composition has a deflection temperature under load (at 1.80 MPa) of 83° C. or more.

3. The interior/exterior automotive trim component of claim 1, wherein
the component has a notched Charpy impact strength of 100 kJ/m² or more when a notch tip R is located at 0.75 mm.

4. The interior/exterior automotive trim component of claim 1, wherein
each of the plurality of carbonate copolymers includes the ISB unit at a ratio of 90 mol % or less with respect to the structural unit derived from every one of the dihydroxy compounds that form the plurality of carbonate copolymers.

5. The interior/exterior automotive trim component of claim 1, wherein
if the sum of the plurality of different carbonate copolymers is 100 parts by weight, the polycarbonate resin composition includes 0.2 to 50 parts by weight of an elastic polymer.

6. The interior/exterior automotive trim component of claim 1, wherein
the component is formed by injection molding.
